(19) United States
(12) Patent Application Publication
(10) Pub. No.: US 2013/0137304 A1
(43) Pub. Date: May 30, 2013

(54) ELECTRICAL CONNECTOR

(71) Applicant: SHENG-YUAN HUANG, New Taipei (TW)

(72) Inventor: SHENG-YUAN HUANG, New Taipei (TW)

(73) Assignee: Cheng Uei Precision Industry Co., LTD., New Taipei City (TW)

(21) Appl. No.: 13/304,405

(22) Filed: Nov. 24, 2011

(51) Int. Cl. H01R 24/28

(52) U.S. Cl. 439/626

(57) ABSTRACT

An electrical connector is provided, including a housing, an inserting groove, a plurality of terminal-receiving grooves spaced with each other on two sidewalls of the housing and passing through a bottom plate of the housing, and a plurality of electrical terminals integrally formed in the terminal-receiving grooves by an insert molding method. Each electrical terminal includes a U-shaped latch portion. An outer surface of the latch portion protrudes out of a peripheral edge of the sidewall of the housing to prevent from producing the overflow plastic during the process of the insert molding. Moreover, the latch portion disposes a first and a second recesses on two opposite sides thereof. When the electrical connector is combined with a complementary connector, the first and the second recesses of each electrical terminal can form a two-position contact with a complementary terminal of the complementary connector for assuring a stable electrical transmission.

### BACKGROUND OF THE INVENTION

1. Field of the Invention

The present invention relates to an electrical connector, and more particularly to an electrical connector, which has a plurality of electrical terminals being insert molded with it, avoiding producing the overflow plastic, providing a two-position contact and assuring a stable electrical transmission.

2. Description of the Prior Art

At present, a connector mainly includes a housing and a plurality of electrical terminals. The connector is mounted on a circuit board for being mated with a complementary connector. By the electrical terminals of the two connectors contacting with each other, the two connectors form an electrical transmission therebetween. Therefore, the configuration of the electrical terminal is one of the main factors of whether the electrical terminal can provide a stable contact. In view of this, the traditional connector ordinarily disposes a plurality of electrical terminals, which are mounted in the housing by an inserting mode. Each electrical terminal has a contact end protruding from the housing and a solder portion soldered onto a circuit board. The contact end is used to contact with a complementary terminal of a complementary connector. However, the configuration of the traditional electrical terminal provides only one single position to contact with the complementary terminal and the traditional electrical terminal is fixed in the housing only by an interference fit, so that it is easy to escape from the housing and fail to contact with the complementary terminal when the connector suffers from the factors of the external shocks and the like. That will result in the problems of unstable signal transmission or even signal interruption and so on. These problems are especially easy to occur in a board-to-board connector having multiple electrical terminals.

### BRIEF SUMMARY OF THE INVENTION

For overcoming above defects, an object of the present invention is to provide an electrical connector, which has a plurality of electrical terminals being insert molded with it, avoiding producing the overflow plastic, providing a two-position contact, and being capable of forming a stable electrical contact and a stable combination with a complementary terminal to provide a stable signal transmission being not easy to be effected by external shocks.

To achieve the above object, in accordance with the present invention, an electrical connector is provided, comprising a housing, an inserting groove, a plurality of terminal-receiving grooves and a plurality of electrical terminals. The housing is made of insulating material and has two opposite end walls, two sidewalls connected to the two end walls and spaced each other, and a bottom plate connecting bottoms of the two end walls and the two sidewalls. The inserting groove is defined between the two end walls, the two sidewalls, and the bottom plate. The terminal-receiving grooves are formed on the two sidewalls, are spaced with each other and pass through the bottom plate. The electrical terminals are integrally formed in the terminal-receiving grooves by an insert molding method. Each of the electrical terminals includes a latch portion, which is U-shaped and has an inter surface and an outer surface. The outer surface of the latch portion protrudes out of a peripheral edge of the corresponding sidewall. Because one side of the latch portion of each electrical terminal is opened to the inserting groove and the latch portion protrudes from the corresponding sidewall of the housing, the electrical connector of the present invention can prevent from producing the overflow plastic during the process of the insert molding.

Moreover, for achieving the above object, the latch portion disposes a first recess on one side thereof facing the inserting groove, and disposes a second recess on the other side thereof opposite to the inserting groove. The first and the second recesses of the electrical terminal can form a two-position contact with a complementary terminal for assuring a stable electrical transmission.

### BRIEF DESCRIPTION OF THE DRAWINGS

FIG. 1 is a perspective view of an electrical connector of the present invention and a complementary connector.

FIG. 2 is an assembly view of FIG. 1.

FIG. 3 is a schematic view of an electrical terminal of the electrical connector of the present invention.

FIG. 4 is a sectional view of the electrical connector of the present invention.

FIG. 5 is a schematic view of the engagement process of the electrical terminal and a complementary terminal.

### DETAILED DESCRIPTION OF THE PREFERRED EMBODIMENTS

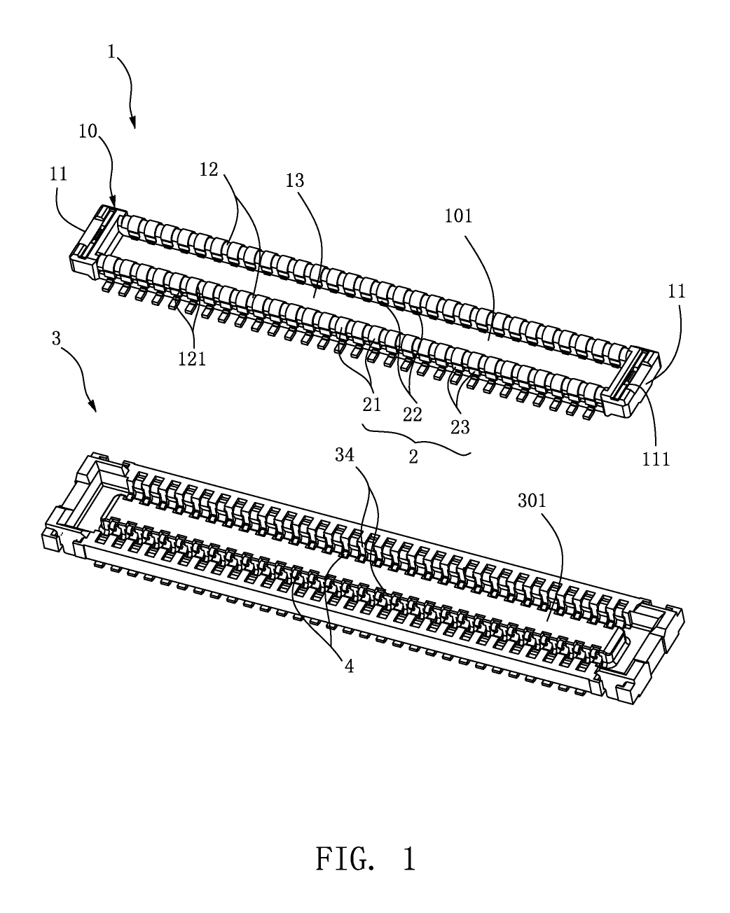

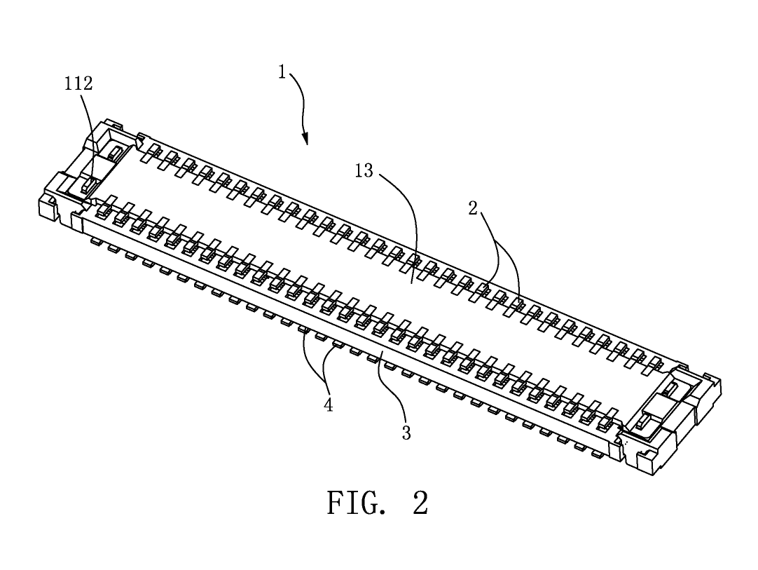

Please refer to FIGS. 1 to 4, which are one preferred embodiment of an electrical connector 1 of the present invention, the electrical connector 1 comprises a housing 10 being rectangular strip-shaped and being made of insulating material. The housing 10 has two opposite end walls 11 extending along a short axis thereof, two opposite sidewalls 12 extending along a long axis thereof, and a bottom plate 13 connecting bottoms of the two end walls 11 and the two sidewalls 12. Each of the two end walls 11 disposes a positioning groove 111 passing through a top and bottom surfaces thereof. A flux member 112 (as shown in FIG. 2) is mounted in the positioning groove 111 for strengthening the connection of the housing 10 and a circuit board (not shown in all FIGS.). The electrical connector 1 further comprises an inserting groove 101 together defined by the two end walls 11, the two sidewalls 12 and the bottom plate 13, and a plurality of terminal-receiving grooves 121 being formed on the two sidewalls 12, being spaced with each other and passing through the top and bottom surfaces of the bottom plate 13. The electrical connector 1 further comprises a plurality of electrical terminals 2 being punched by metal material. Each electrical terminal 2 includes a latch portion 21, which is U-shaped and has an inner surface 211 and an outer surface 212.

It is particularly mentioned that: the electrical terminal 2 is formed in the corresponding terminal-receiving groove 121 by an insert molding method, which is different from the interference fit in prior art. The electrical connector 1 of the present invention adopts the insert molding method to make the electrical terminals 2 and the housing 10 be integrally formed and be stably combined together. The inner surface 211 of the latch portion 21 and two sides 210 thereof adjacent to the inner surface 211 cover the corresponding terminal-receiving groove 121 (as shown in FIG. 4) so that efficiently enhancing the strength of the electrical terminal 12 and the combination of the electrical terminal 12 and the housing 10. Namely, the electrical terminal 12 is not easy to escape from the housing 10 because of the frequent inserting and pulling out. Furthermore, for avoiding producing the overflow plastic in the insert molding process, the outer surface 212 of the latch portion 21 protrudes out of the peripheral edge of the corresponding sidewall 12, so that the plastic cannot overflow the outer surface 212 of the electrical terminal 2 to affect the contact surface of the electrical terminal.

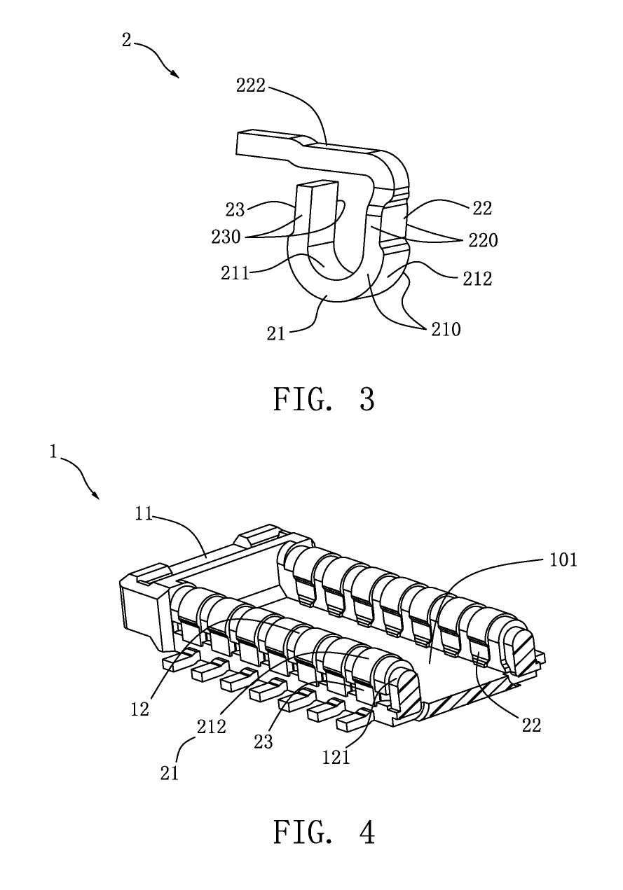

Please refer to FIG. 3, another feature of the electrical terminal 2 is that: two opposite outer surfaces 212 of the latch portion 21 respectively dispose a first recess 22 and a second recess 23. The first and the second recesses 22, 23 are concaved inward from the outer surface 212 of the latch portion 21, and protrude out of the peripheral edge of the corresponding sidewall 12. The first recess 22 is adjacent to and opens to the inserting groove 101. One end of the recess 22 is further bent and extends to form a solder portion 222, which is partially located in the bottom plate 13 and partially exposed out of the housing 10 for being soldered onto the circuit board (not shown in all FIGS.). The part of the solder portion 222 embedded in the bottom plate 13 is located above the second recess 23, and the part of the solder portion 222 and the latch portion 21 together clamp the bottom plate 10.

In this preferred embodiment, the first and the second recesses 22, 23 are flat-shaped to increase the contact area with a complementary terminal. Two transverse opposite sides 220, 230 of the first and the second recesses 22, 23 are respectively opened to and connected to the two sides 210 of the latch portion 21 (as shown in FIG. 3). And two longitudinal opposite sides of the first recess 22 are concaved inward from the outer surface 212 of the latch portion 21 to form an arc edge or an inclined edge, which can be used to guide the complementary terminal to be positioned. The second recess 23 has one longitudinal side, which is opposite to the solder portion 222 and is connected to the latch portion 21 to be concaved inward from the outer surface 212 of the latch portion 21 to also form an arc edge or an inclined edge.

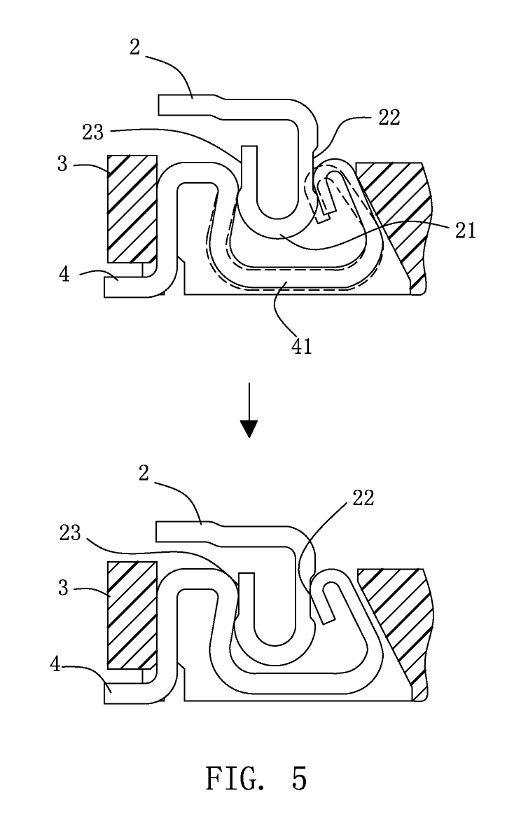

Please refer to FIG. 1, the electrical connector 1 may be combined with a complementary connector 3. The complementary connector 3 comprises a protruding plate 301 corresponding to the inserting groove 101 of the electrical connector 1, two engaging grooves 34 accommodating the two sidewalls 12 and a plurality of complementary terminals 4. Please continuously refer to FIGS. 2 and 5, when the electrical connector 1 of the present invention and the complementary connector 3 are mated together, the inserting groove 101 of the electrical connector 1 can accommodate the protruding plate 301 of the complementary connector 3, and the two sidewalls 12 of the inserting groove 101 are respectively inserted into the two engaging grooves 34 (as shown in FIG. 2). During the engaging course, the outer surface 212 of the latch portion 21 of the electrical terminal 2 first contacts the complementary terminal 4 of the complementary connector 3, and then the electrical terminal 2 is continuously inserted to be positioned. Now, both the flat-shaped first and the second recesses 22, 23 contact with the complementary terminal 4 so that realizing a two-position contact between the electrical terminal 2 and the complementary terminal 4.

As described above, the electrical connector 1 of the present invention adopts the insert molding method to make the electrical terminals 2 and the housing 10 be integrally formed and be stably combined together. The outer surface 212 of the electrical terminal 2 protrudes out of the peripheral edge of the corresponding sidewall 12, so that avoiding producing the overflow plastic in the process of insert molding to affect the contact surface of the electrical terminal. Moreover, the first and the second recesses 22, 23 of the latch portion 21 can form a two-position contact with the complementary terminal for assuring a stable electrical transmission.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
a housing, being made of insulating material and having two opposite end walls, two sidewalls connected to the two end walls and spaced each other, and a bottom plate connecting bottoms of the two end walls and the two sidewalls;
an inserting groove, being defined between the two end walls, the two sidewalls, and the bottom plate;
a plurality of terminal-receiving grooves, being formed on the two sidewalls, being spaced with each other and passing through the bottom plate; and
a plurality of electrical terminals, being integrally formed in the terminal-receiving grooves by an insert molding method, each of the electrical terminals including a latch portion, which is U-shaped and has an inter surface and an outer surface, the outer surface of the latch portion protruding out of a peripheral edge of the corresponding sidewall.

2. The electrical connector as claimed in claim 1, wherein the inner surface of the latch portion and two sides of the latch portion adjacent to the inner surface together cover the corresponding terminal-receiving groove.

3. The electrical connector as claimed in claim 1, wherein the latch portion disposes a first recess on one side thereof facing the inserting groove, and disposes a second recess on the other side thereof opposite to the inserting groove.

4. The electrical connector as claimed in claim 3, wherein one end of the first recess is bent and extends to form a solder portion, which is partially located in the bottom plate and partially exposed out of the housing; the part of the solder portion embedded in the bottom plate is located above the second recess and is together with the latch portion to clamp the bottom plate.

5. The electrical connector as claimed in claim 3, wherein the first and the second recesses are flat-shaped, and two transverse opposite sides of the first and the second recesses are respectively opened to and connected to two sides of the latch portion.

6. The electrical connector as claimed in claim 3, wherein the first and the second recesses protrude out of a peripheral edge of the corresponding sidewall of the housing.

7. The electrical connector as claimed in claim 1, wherein the housing disposes two flux members respectively mounted in the two end walls thereof.
